(19) United States
(12) Patent Application Publication
(10) Pub. No.: US 2010/0274284 A1
(43) Pub. Date: Oct. 28, 2010

(54) BODY ALIGNMENT APPARATUS

(76) Inventor: Debra COSGROVE, Stony Plain (CA)

Correspondence Address: DAVIS & BUJOLD, P.L.L.C., 112 PLEASANT STREET, CONCORD, NH, 03301, US

(21) Appl. No.: 12/431,212

(22) Filed: Apr. 28, 2009

(51) Int. Cl. A61H 1/00

(52) U.S. Cl. 606/237

(57) ABSTRACT

A body alignment apparatus includes a body having an underlying foot engaging surface. The body is sufficiently wide to provide a minimum width sufficient to accommodate a width of a pair of feet placed side by side, and sufficiently long to provide a minimum length sufficient to accommodate a length of the pair of feet from heel to at least as far as the balls of the feet. There is an X-axis level indicator for indicating whether the body is level along an X-axis, and a Y-axis level indicator for indicating whether the body is level along a Y-axis.

### FIELD

An apparatus for ensuring that one's body is properly aligned.

### BACKGROUND

When our bodies are out of alignment—even if not due to injury—muscles over-work and over-compensate beyond their intended functionality. This sets into motion a series of successive misalignment effects resulting in imbalances throughout the body which manifest as discomfort, pain, and even disease since anatomical changes may directly or indirectly produce physiological consequences which, in turn, ultimately affect emotional and psychological well-being.

Injury, exercise, various habits, posture, gait, even genetic factors, etc., can cause muscles to develop in an unbalanced way. Prolonged periods of muscular imbalance distort bone structure (resulting in bone degeneration): one side of the body might be “loose”, the other “tight”. This distortion, in turn, places unnatural tension on our vertebrae, resulting in inhibiting and even blocking the flow of the “life force” (life energy) in some areas of the body, and in time affecting our organs and glands and thus ultimately our emotional and thinking processes.

Most devices and processes used for the re-alignment of the human body do not deal with the imbalances and alignment problems by checking the symmetry and balance of the feet. It is much more common among practitioners correcting structural alignment problems in the human body, especially for those practicing chiropractic, to focus on the patient's spinal alignment.

### SUMMARY

There is provided a body alignment apparatus, comprising a body having an underlying foot engaging surface. The body is sufficiently wide to provide a minimum width sufficient to accommodate a width of a pair of feet placed side by side, and sufficiently long to provide a minimum length sufficient to accommodate a length of the pair of feet from heel to at least as far as the balls of the feet. There is an X-axis level indicator for indicating whether the body is level along an X-axis, and a Y-axis level indicator for indicating whether the body is level along a Y-axis.

There is provided a method of aligning a human body, comprises providing a body alignment apparatus, as described above. A back of a person is positioned against a horizontal surface with their legs extending vertically. The body alignment apparatus is positioned with a pair of feet of the person engaging the underlying feet engaging surface. The orientation of the feet is positioned until both the X-axis level indicator and the Y-axis level indicator indicate a level position. The level position is maintained for a predetermined amount of time.

Using the apparatus and the method, as described above, enables one to align their body from the bottom up. This alignment starts with the feet, then the ankles, then the legs and finally to the spine.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of the body aligner.

FIG. 2 is a top plan view of the body aligner.

FIG. 3 is a side elevation view of the body aligner.

FIG. 4 is a side elevation view of the body aligner in use.

### DETAILED DESCRIPTION

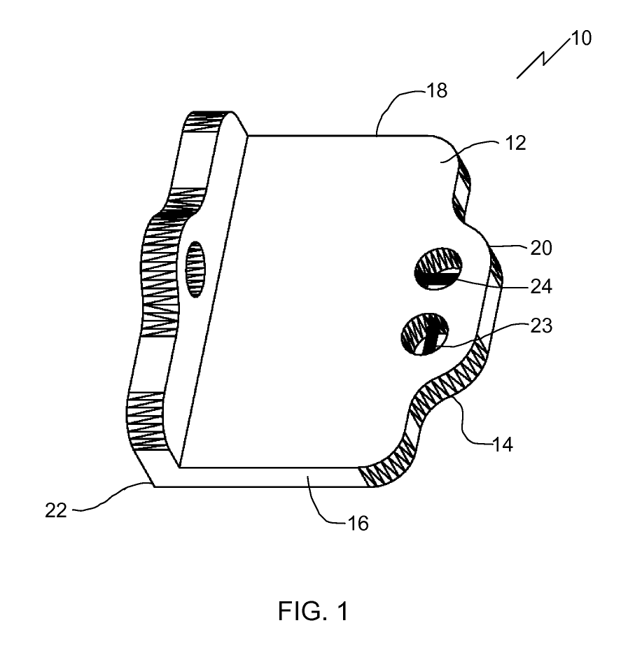

A body aligner, generally identified by reference numeral 10, will now be described with reference to FIG. 1 through 4.

The body aligner's efficacy is based on well-established chiropractic, neuromuscular, and myofascial rationale. This rationale stipulates that structural misalignment in one area creates misalignment and imbalance in another area, consequently in another, etc., much like a “domino effect”. Ultimately, this creates rampant muscular disarray which, in turn, produces other complaints, injuries, and disorders.

The traditional focus on the spine fails to take into account that the human body's foundation for proper alignment begins with the feet. The body aligner as described herein can detect and correct structural alignment problems in the feet, ankles, knees, hips, etc.—the human body's true structural foundation in order to properly address the alignment of the spine.

Our feet are the foundation of our body. Just like the foundation of a building must be square and stable in order for the structure above it to be strong, so must be with our feet. We must therefore start with the correction of the two points that balance and stabilize our entire body's structure. By targeting the feet first, the body aligner enables its user to detect and address their own “foundation's” (feet's) dissymmetry as a first step to correcting their total body's alignment problems and, consequently, related imbalances.

There is an interrelationship between the muscles, tendons, ligaments, and bones. Free and easy movement is activated when muscles and bones are properly aligned. A re-balancing of the body's muscular and structural components with then end of achieving optimal alignment is the therapeutic rationale fundamental to the body aligner.

### Structure

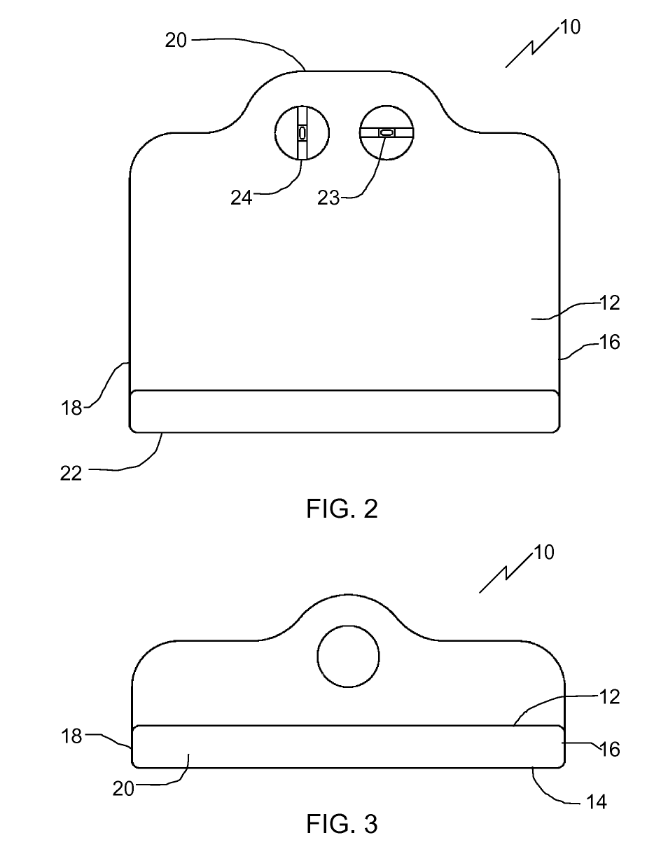

Referring to FIG. 1, body alignment apparatus 10 includes a body 12 having an underlying foot engaging surface 14 that is a substantially flat. It must be noted that when body 12 has an opposed surface that is also substantially flat, body 12 could be flipped over and used in either orientation. Referring to FIGS. 2 and 3, body 12 has a first side edge 16 and a second side edge 18 separated by a width of body 12, and a front edge 20 and a back edge 22 separated by a length of body 12. The width of body 12 is sufficiently wide to provide a minimum width sufficient to accommodate a width of a pair of feet placed side by side, and the length of body 12 is sufficiently long to provide a minimum length sufficient to accommodate a length of the pair of feet from heel to at least as far as the balls of the feet. If the length of body 12 extends to the toes or even past the toes, that is acceptable and should not adversely effect performance. A level indicator, in this case two spirit levels 23 and 24, for indicating the orientation of body 12 in the X-axis and in the Y-axis. Levels 23 and 24 indicate a level position when foot engaging surface 14 is parallel to a level ground surface. In some embodiments, there may be straps (not shown) on the bottom of body 12 to strap the feet to body 12.

As depicted, the level indicator comprises two spirit levels 23 and 24: spirit level 23 indicates the side-to-side orientation, or the orientation along the X-axis, and spirit level 24 indicates the front-to-back orientation, or the orientation along the Y-axis. It will be recognized that other level indicators and arrangements may be used. For example, a single two-dimensional spirit level may also be used. Levels 23 and 24 are preferably viewable from the orientation of foot engaging surface 14 to allow a person to determine the orientation of the body while supporting the body on the person's feet.

### Benefits

Use of the body aligner takes practice, as we are aligning the body. Practicing five to twenty minutes daily (holding position as long as possible), combined with passive mental involvement and regular breathing patterns, produces a “new normal” for body alignment.

While lying with the legs extended upward against a wall and making muscular adjustments based upon an observably quantified optimally level state, the user of the body aligner holds this position while the desired muscular release occurs naturally. As a result, re-alignment occurs, much in the manner of a perfectly controlled static stretch. As a condition of structural normalcy for the body aligner user is approached, much more healthy musculoskeletal function is achieved.

Regular use of the body aligner therefore facilitates structural re-alignment of the body by rebalancing crucial alignments, beginning with the feet, and consequently inducing a correctional effect upward through the legs, pelvis, and ultimately the lower spine. (The length of time required to produce optimal alignment is contingent upon the severity and duration of the structural malady.) The main benefits of the body aligner include:
Effecting restored function of and restored range of motion to the diagnosed problem areas.
Reducing and/or eliminating pain in one or more areas of the body.
Causing over-all body movement to be smoother and easier while stimulating healthy bodily functions and enhancing conscious awareness of optimal body alignment with regular use of the body aligner

In summary, the body aligner promotes strong and stable bodies by establishing optimal muscle balance throughout the entire body.

### Operation:

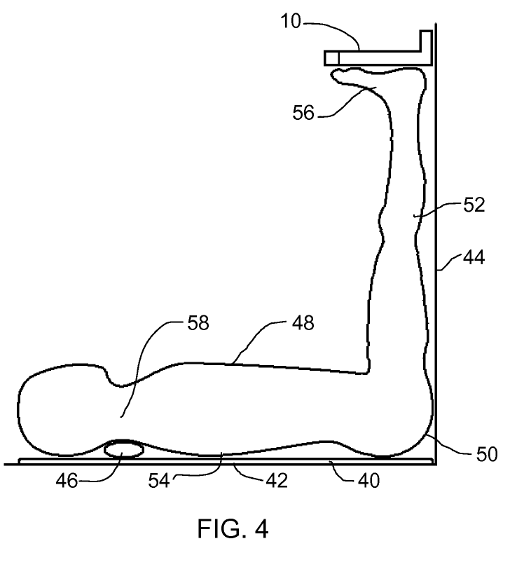

A preferred method of use involves the steps outlined below, and depicted in FIG. 4. Other steps may be included, or certain steps excluded or modified, depending on the preferences of the user, as will be apparent to those in the art. Fold a blanket 40 the width of hips and the length of upper body (hips to head). Place it length-wise on the floor 42, its far length end abutting the wall 44. Roll a hand towel 46 three (3) to four (4) inches thick. Keep within reach, for neck support. Keep the body aligner 10 within reach. Users 48 of the body aligner 10 should lie on the floor in the static stretch, with buttocks 50 touching floor 42 and wall 44, and with both legs 52 upright against the wall 44, directly perpendicular to the back 54 and floor 42, as this position produces the least amount of pressure on the lumbar spine, and the resulting stress reduction is critical in both the diagnostic and healing process.

The buttocks may be positioned by the wall using different methods. First, position body parallel to the wall, lying down on back, with one side touching the wall. Lean over to the opposite side (away from the wall), while raising legs up and against the wall. The upper body section of one buttock to the head remains on blanket, as near to the wall as possible, eventually touching the wall as outstretched legs gradually move up the wall and the upper body naturally turns back toward the wall during the legs' gradual “climb” to a vertical position perpendicular to the floor. Another way is to sit down facing the wall. Bend knees and pull to chest. Lay back and down on blanket in as crouched position as possible. Place bottoms of feet on the wall and wiggle close to the wall as possible so that the buttocks touches the wall at its intersection with the floor.

Once positioned against the wall, bend knees back toward chest. Place the body aligner 10 at rest on the bottoms of the feet 56, which are positioned flat against and support the “back” of the body aligner 10 so that it is parallel to the floor 42 and perpendicular to the wall 44. Extend legs 52 vertically, with legs parallel, as far up and straight as possible so that the backs of the legs 52 are touching the wall 44 and are perpendicular to the floor 42. If necessary, reach for and place the rolled towel 46 under neck 58 for support (optional). Gradually raise and straighten legs 52, lifting the body aligner 10 slowly at the same time, while keeping the body 48 on the floor straight (shoulders are “over” hips in a straight line). Be sure the body's position enables the pelvis to sit neutrally on the floor. If the pelvis does not sit neutrally on the floor, it may be that the hips are out of alignment. This will gradually correct itself through repeated use of body alignment apparatus 10. Once the legs 52 are extended as much as possible while holding the body aligner 10 with feet 56 and lying as comfortable as possible, focus on the relaxation of shoulders, arms, neck, jaw, and face. Tighten thighs and flex feet and toes back, shifting feet, legs, hips, feet and toes while keeping eyes on the two bubbles in the levels, so as to manipulate the orientation of the feet until both the two bubbles in levels 23 and 24 (depicted in FIG. 2) arrive at their centers, indicating a level position along both the X-axis and the Y-axis.

The bubbles may be brought to their centers by hold the body aligner 10 as steady as possible with the feet 56. Adjust the 56 feet by spreading toes and tilting ankles to one side or the other and tilting the heels or toes (depending on the bubble level reading) up or down. The objective is to maintain support of the body aligner 10 with the bottoms of the feet 56 such that it is perfectly level in both directions, according to the readings of the two bubble levels (which are perpendicular to each other). This process requires continual adjustments and corrections in miniscule increments to achieve perfect balance of the body aligner platform. By ever so slightly shifting the position of the feet, toes, ankles, knees, hips, abdominal muscles, thighs, or even the chest and shoulders, the leveling mechanism of the body aligner produces a precise level reading in both directions (left to right & back to front). Centered bubble readings of the body aligner indicate aligned feet, ankles, knees, hips, and so on upwards. This is the actual reading goal to reach and maintain.

Once centered, focus on an even (equal distribution of) pressure of the feet against the weight of the body aligner via three (3) points of a triangle (inverted “pyramid”) per sole on each foot. The first point of the “pyramid” is the center of the heel, the second point of the “pyramid” is on the “ball” of the foot under the big toe, and the third point of the “pyramid” is under the little toe on the other “ball” of the foot. In some situations it may be beneficial to place extra weight, such as a telephone book, on top of body 12 in order to apply additional pressure.

Spreading the toes, continue to press the outside of the heels up into the platform of the body aligner while lifting the left little toe only. From the hips, shift straightened legs up or down (toward or away from the ceiling) to align leg length. The objective is to reach and maintain even weight distribution of the body aligner atop the “pyramid” on the sole of each foot simultaneously. For each leg and on each foot, line up the hip bone straight in line with the center of the knee, which is to be lined up straight in line with the shin bone, which is to be lined up straight in line to the center of the top front of the ankle and to the second toe or web between the first and second toes. This is the goal for perfect alignment. When the ideal level readings are established, relax and gently hold the position, breathing normally. Relaxation in the correctly aligned state is important as only then will the body “settle” in to the correct state of muscular-skeletal alignment, so as to cause a “release” which triggers the healing process. A “release” occurs most readily when the body finds proper alignment on its own rather than being forced.

Each attempt should be timed, and holding position for at least two (2) to three (3) minutes to start. Work up to ten (10) to twenty (20) minutes per session, two (2) to four (4) times a day. At the end of each session or attempt, raise hands to grasp the body aligner and, while bending both legs to bring the body aligner down the wall, grasp the body aligner and place it on the floor. Sit up and stand.

### Benefits

It is believed that a “new normal” for body alignment is produced and structural re-alignment of the body is facilitated when the body aligner is used regularly, such as for five (5) to ten (10) minutes daily and may be combined with passive mental involvement and regular breathing patterns.

The length of time required to produce optimal alignment is contingent upon the severity and duration of the structural malady. Besides daily, routine use of the body aligner for gradual re-alignment and maintenance, the following are instances and conditions when the body aligner may also be used for therapy:
Injury therapy
As part of one's physical exercise routine
Pain control
Vericose veins
Swelling of the legs
Shoulder and hip disengagement
Increase body awareness
Chronic conditions
Torqued hips
Spinal conditions
Flat feet
Various conditions of the feet, ankles, toes, knees, legs, hips, lower back, and spine.

### Example 1 of Body Misalignment's “Domino Effect”

A demonstration of muscle imbalance creating structural issues may be found in a common ailment referred to as plantar faciitis, the constriction of all the muscle layers on the sole of the foot (abductor hallicis, flexor digitorum brevis, abductor digiti mimimi, quadratus plantae, lumbricales, flexor hallucis brevis, abductor hallucis, flexor digiti minimi brevis, and interossei).

Plantar faciitis results in the patient walking with an inversion in order to decrease pressure on the arch of the foot. This, in turn, creates undue pressure laterally on the knee as the peroneal muscles (responsible for eversion of the foot) pull the arch of the foot at the insertion point and become tighter at the origin on the upper portion of the lateral surface of the fibula. This pulls the fibular away from the tibia, creating issues with the patellar tendon and its insertion at the tibial tuberosity.

Problems with patellar tracking, in turn, create joint issues through the hip by either pulling medially or laterally in the ilium, depending on which of the quadracep muscles is tighter. If the ilium is pulled laterally, it constricts the muscles of the lower back, creating a lordosis resulting in stretched abdominal muscles. This imbalance of the lower back or “core” muscles then results in tightness along the spinal column which can then pull the ribs out of alignment, causing stress on the diaphragm, making breathing and proper digestion of food progressively difficult. This tightness will also cause the erector spinae grouping to contract and pull on the base of the occipital bone, creating headaches and shoulder problems which, in turn, inhibit one's ability to optimally move through the shoulder complex. Common issues here are rotator cuff or deltoid strains, pulls through the sternum, tendonitis of the elbow (“tennis elbow”), and carpal tunnel syndrome.

### Example 2 of Body Misalignment's “Domino Effect”

In addition to tight or imbalanced leg, ankle, and feet muscles, the pelvis may be in an unbalanced state. As conditions worsen, the imbalance continues to move up the body, possibly creating headaches in some. Depending on how chronic the condition is, there may be dysfunction in the spinal vertebrae all the way to the top of the spinal column as well.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A body alignment apparatus, comprising:
a body having an underlying foot engaging surface, the body being sufficiently wide to provide a minimum width sufficient to accommodate a width of a pair of feet placed side by side, and sufficiently long to provide a minimum length sufficient to accommodate a length of the pair of feet from heel to at least as far as the balls of the feet; and
an X-axis level indicator for indicating whether the body is level along an X-axis; and
a Y-axis level indicator for indicating whether the body is level along a Y-axis.

2. The body alignment apparatus of claim 1, wherein the X-axis level indicator and the Y-axis level indicator comprise spirit levels.

3. The body alignment apparatus of claim 1, wherein the level indicator is viewable from the orientation of the foot engaging surface.

4. The body alignment apparatus of claim 1, wherein straps are provided to strap the pair of feet to the body.

5. A method of aligning a human body, comprising:
providing a body alignment apparatus, comprising:
a body having an underlying foot engaging surface, the body being sufficiently wide to provide a minimum width sufficient to accommodate a width of a pair of feet placed side by side, and sufficiently long to provide a minimum length sufficient to accommodate a length of the pair of feet from heel to at least as far as the balls of the feet; and
an X-axis level indicator for indicating whether the body is level along an X-axis; and
a Y-axis level indicator for indicating whether the body is level along a Y-axis;
positioning a back of a person against a horizontal surface with their legs parallel and extending vertically;
positioning the body alignment apparatus with a pair of feet of the person engaging the underlying feet engaging surface;
manipulating the orientation of the feet until both the X-axis level indicator and the Y-axis level indicator indicate a level position;
maintaining such level position for a predetermined amount of time.

6. The method of claim 5, wherein the person is assisted in extending and maintaining their legs vertically, by placing their legs against a vertical surface.
